(19) United States
(12) Patent Application Publication
(10) Pub. No.: US 2026/0303543 A1
(43) Pub. Date: Oct. 1, 2026

(54) ARTIFICIAL INTELLIGENCE (AI) BASED METHOD AND SYSTEM FOR ALLOCATING DYNAMIC BANDWIDTH BASED ON USER EXPERIENCE

(71) Applicant: HCL Technologies Limited, New Delhi (IN)

(72) Inventors: Sidhananda Karthikeyan Sivaprakasam, Chennai (IN); Ganesh Parthasarathy, Chennai (IN)

(21) Appl. No.: 19/444,277

(22) Filed: Jan. 9, 2026

(30) Foreign Application Priority Data
Mar. 28, 2025 (IN) 202511030021

(51) Int. Cl. H04L 47/76; H04L 47/24; H04W 72/04

(52) U.S. Cl. CPC H04L 47/76; H04L 47/24; H04W 72/04

(57) ABSTRACT

This disclosure relates to an Artificial Intelligence (AI) based method and system for allocating dynamic bandwidth to User Equipments (UEs). The method may include iteratively extracting a set of key performance indicators (KPIs) associated with user experience data from Over The Top (OTT) applications associated with a UE of a user. The method may further include retrieving network telemetry data associated with a network being used by the UE. The method may further include processing, by an AI model, the set of KPIs and the network telemetry data. The method may further include determining, by the AI model, a bandwidth required by the UE in the network based on a result of the processing.

### DESCRIPTION

### TECHNICAL FIELD

This disclosure relates generally to allocating dynamic bandwidth, and more particularly to Artificial Intelligence (AI) based method and system for allocating dynamic bandwidth based on user experience.

### BACKGROUND

Nowadays, mobile users may face significant challenges with static Quality of Service (QoS) settings tied to the plans of the mobile users. The QoS settings may not adjust dynamically based on needs of the mobile users, particularly during critical tasks (for example, video calls, gaming, work related activities while commuting, etc.) leading to poor user experience. The user may suffer from degraded network performance during important moments (for example, work related important meeting). Meanwhile, telecom service providers may face another challenge i.e., monetization of 5G networks. Despite advanced capabilities of 5G networks, the telecom operators may struggle to capitalize on full potential of technology due to lack of dynamic pricing models aligining with user needs.

Thus, the present invention is directed to overcome one or more limitations stated above or any other limitations associated with the known arts.

### SUMMARY

In one embodiment, an Artificial Intelligence (AI) based method for allocating dynamic bandwidth to User Equipments (UEs) is disclosed. In one example, the method may include iteratively extracting a set of key performance indicators (KPIs) associated with user experience data from Over The Top (OTT) applications associated with a UE of a user. The method may further include retrieving network telemetry data associated with a network being used by the UE. The method may further include processing, by an AI model, the set of KPIs and the network telemetry data. The method may further include determining, by the AI model, a bandwidth required by the UE in the network based on a result of the processing.

In another embodiment, AI based system for allocating dynamic bandwidth to UE is disclosed. In one example, the system may include a processor and a computer-readable medium communicatively coupled to the processor. In one example, the computer-readable medium may store processor-executable instructions, which, on execution, may cause the processor to iteratively extract a set of key performance indicators (KPIs) associated with user experience data from Over The Top (OTT) applications associated with a UE of a user. The processor-executable instructions, on execution, may further cause the processor to retrieve network telemetry data associated with a network being used by the UE. The processor-executable instructions, on execution, may further cause the processor to process, by an AI model, the set of KPIs and the network telemetry data. The processor-executable instructions, on execution, may further cause the processor to determine, by the AI model, a bandwidth required by the UE in the network based on a result of the processing.

In yet another embodiment, a non-transitory computer-readable medium storing computer-executable instructions for allocating dynamic bandwidth to UE using AI is disclosed.

In one example, the stored instructions, when executed by a processor, may cause the processor to iteratively extract a set of key performance indicators (KPIs) associated with user experience data from Over The Top (OTT) applications associated with a UE of a user. The operations may further include retrieving network telemetry data associated with a network being used by the UE. The operations may further include processing, via an AI model, the set of KPIs and the network telemetry data. The operations may further include determining, via the AI model, a bandwidth required by the UE in the network based on a result of the processing.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary network for allocating dynamic bandwidth to User Equipments (UEs) using Artificial Intelligence (AI), in accordance with some embodiments.

FIG. 2 illustrates a flow diagram of an exemplary process for allocating dynamic bandwidth to UEs using AI, in accordance with some embodiments.

FIG. 3 illustrates a flow diagram of an exemplary process for processing a set of KPIs and the network telemetry data using AI, in accordance with some embodiment.

FIG. 4 illustrates a flow diagram of a detailed exemplary process for allocating dynamic bandwidth to UEs using AI, in accordance with an embodiment.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

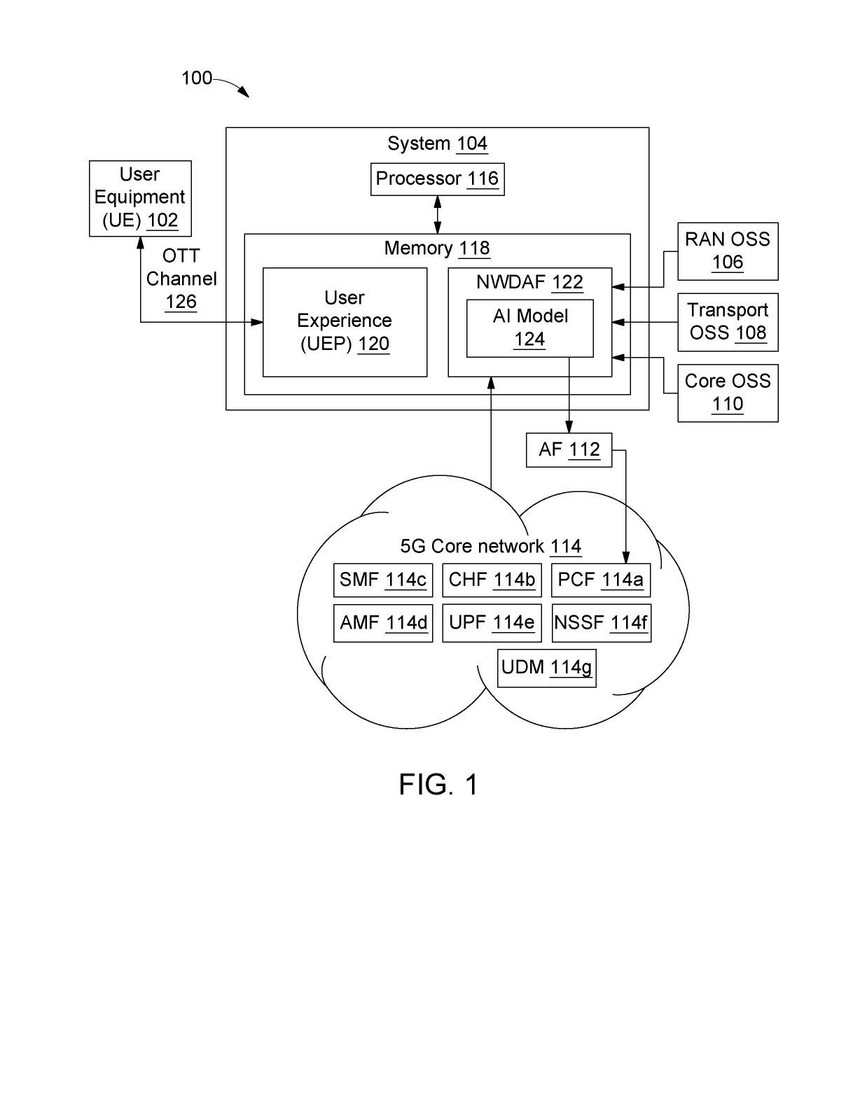

Referring now to FIG. 1, an exemplary network 100 for allocating dynamic bandwidth to User Equipments (UEs) using Artificial Intelligence (AI) is illustrated, in accordance with some embodiments. The exemplary network 100 may include a UE 102 of a mobile user, a system 104, a Radio Access Network (RAN) Operation Support System (OSS) 106, a transport OSS 108, a core OSS 110, an Application Function (AF) 112, and a 5G core network 114 (or any other core network). It will be apparent that only one UE 102 is shown in FIG. 1, but multiple UEs 102 are withing the scope of the invention. The UE 102, for example, may include, but is not limited to a smartphone, a tablet, a phablet, a laptop, or smart glasses. In some embodiments, the system 104 may be any network device (for example, a Base Station Subsystem (BSS), a Base Station Controller (BSC), a Base Transceiver Station (BTS), or a Backhaul system) or may be located within in a separate server independent of a network provider. The system 104 may include a processor 116 and a memory 118. The memory 118 may include a cache memory. The memory 118 may store instructions that, when executed by the one or more processors 116, may cause the processor 116 to allocate dynamic bandwidth to the UE 102 and other UEs, in accordance with aspects of the present disclosure. The memory 118 may also store various data (for example, a set of Key Performance Indicators (KPIs), user experience data, network telemetry data, or the like) that may be captured, processed, and/or required by the system 104.

The system 104 may include, within the memory 118 a User Experience Platform (UEP) 120, and a Network Data Analytics Function (NWDAF) 122. The NWDAF 122 may include an AI model 124. The UEP 120 may iteratively extract user activity data (which may include user experience) directly from user experience via Over The Top (OTT) applications (for example, NETFLIX^{®}, AMAZON^{®} PRIME^{®} VIDEO, SPOTIFY^{®}, etc.) associated with the UE 102. In some embodiments, the user activity data may be extracted through a secured OTT channel 126. The user activity data may include a set of Key Performance Indicators (KPIs) associated with the UE 102. The set of KPIs may include location-based performance metrics, application specific KPIs, latency and response time, packet loss and jitter, user perceived quality, better consumption metrics, signal strength variation, movement-related performance, or the like.

The location-based performance metrics may be related to activity of the UE 102 at one or more locations (for example, home, office, shopping complex, commuting routes, etc.). By way of an example, the one or more locations may be determined by using Global Positioning System (GPS) or a Service Set Identifier (SSID) of a Wi-Fi network that the UE 102 is connected to. The application-specific KPIs may include performance data for specific applications (for example, streaming, video conferencing, gaming, browsing, etc.). The latency and response time may include a time delay experienced by the UE 102 during a plurality of tasks (for example, webpage loading, video streaming start time, gaming latency, etc.).

The packet loss and jitter may include variability in delivery of a plurality of packets. The variability in delivery of the plurality of packets may affect real-time applications (for example, video calls) running on the UE 102. The user perceived quality may include subjective feedback (for example, user ratings, feedback prompts, etc.) on perceived service quality captured through the OTT applications. The battery consumption metrics may include data impacts of network usage on battery life of the UE 102. The signal strength variation may be real-time signal quality data as observed by the UE 102 in different environments. The movement-related performance may include data on change in network performance as the UE 102 may move (for example, walking, driving, etc.), including handover success and connectivity stability. The UEP 120 may separately store the set of KPIs as per the user level. The UEP 120 may send the set of KPIs to the NWDAF 122.

The NWDAF 122 may retrieve network telemetry data associated with a network being used by the UE 102. The network telemetry data may be retrieved through at least one of the RAN OSS 106, the transport OSS 108, or the core OSS 110. The RAN OSS 106 may include a RAN Intelligent Controller (RIC) and xApps. The RIC may collect and aggregate real-time E2 interface data. The real-time E2 interface data may include a UE-level metrics and a cell-level metrics. The UE-level Metrics may include signal strength and coverage, data rate usage, and Physical Resource Block (PRB) allocation and utilization. The signal strength and coverage may include information on radio signal quality captured by cell sites. The PRB allocation and utilization may include insights of distribution of resources within the RAN. The cell-level metrics may include cell congestion levels, interference metrics, and handover success rates. The cell congestion levels may include real-time data on cell load user distribution. The interference metrics may include details on interference levels affecting communications quality. The handover success rates may include data on effective transfer of UEs between cells during mobility. Further, the xApps may include applications based on AI or Machine Learning (ML) running in the RIC to make real-time decisions for PRB allocation and cell parameter adjustments.

Further, the transport OSS 108 and the core OSS 110 may collect additional network performance metrics. The network performance metrics may include end-to-end latency, jitter, and packet throughput. Further, the AI model 124 in the NWDAF 122 may process the set of KPIs received from the UEP 120 and the network telemetry data received from the transport OSS 108 and the core OSS 110. To process the set of KPIs and the network telemetry data, the AI model 124 may compute dynamic Quality of Services (QoS) required by the UE 102, network related changes, and RAN metrics i.e., the UE-level metrics and the cell-level metrics. Additionally, the AI model 124 may determine occurrence of at least one of network degradation or network congestion at a predefined time period. In other words, the AI model 124 may analyze the set of KPIs to predict network degradation or congestion and may collect data from the RIC through an internal or standardized data collection interface (for example, Open- RAN (O-RAN) defined protocols or proprietary Application Programming Interface (APIs), etc.).

Based on a result of the processing, the AI model 124 may determine a bandwidth required by the UE 102 in the network. Once the bandwidth is determined, the AI model 124 may send the determined bandwidth to the 5G core network 114 through the AF 112. It should be noted that, the AF 112 may act as an orchestrator to communication with the PCF 114a in the 5G core network 114. The 5G core network 114 may include a plurality of functions. The plurality of functions may be essential for mobile communication including mobility management, authentication, authorization, data management, policy control, and QoS. The plurality of functions may include a Policy Control Function (PCF) 114a, a Charging Function (CHF) 114b, a Session Management Function (SMF) 114c, an Access and Mobility Management Function (AMF) 114d, a User Plane Function (UPF) 114e, a Network Slice Selection Function (NSSF) 114f, and a Unified Data Management (UDM) 114g. The PCF 114a may implement a dynamic policy control based on the AF 112 instructions. Additionally, the PCF 114a may communicate updated QoS policy to the SMF 114c. The SMF 114c may enforce policy changes in the UPF 114e for user policy management. Further, the PCF 114a may send the QoS adjustments through the AMF 114d to the RIC in the RAN OSS 106. The RIC may communicate with xApps to execute AI/ML- based decisions for real time cell adjustments (for example, PRB allocations). The RIC may send a status report back to the NWDAF 122 to confirm execution and support continuous learning.

It should be noted that all such aforementioned modules 120 – 124 may be represented as a single module or a combination of different modules. Further, as will be appreciated by those skilled in the art, each of the modules 120 – 124 may reside, in whole or in parts, on one device or multiple devices in communication with each other. In some embodiments, each of the modules 120 – 124 may be implemented as dedicated hardware circuit comprising custom application-specific integrated circuit (ASIC) or gate arrays, off-the-shelf semiconductors such as logic chips, transistors, or other discrete components. Each of the modules 120 – 124 may also be implemented in a programmable hardware device such as a field programmable gate array (FPGA), programmable array logic, programmable logic device, and so forth. Alternatively, each of the modules 120 – 124 may be implemented in software for execution by various types of processors (e.g., processor 116). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for allocating dynamic bandwidth to UEs. For example, the exemplary network 100 and the associated system 104 may include allocating dynamic bandwidth to UEs by the processes discussed herein. In particular, as will be appreciated by those of ordinary skill in the art, control logic and/or automated routines for performing the techniques and steps described herein may be implemented by the system 104 either by hardware, software, or combinations of hardware and software. For example, suitable code may be accessed and executed by the one or more processors on the system 104 to perform some or all of the techniques described herein. Similarly, application specific integrated circuits (ASICs) configured to perform some, or all of the processes described herein may be included in the one or more processors on the system 104.

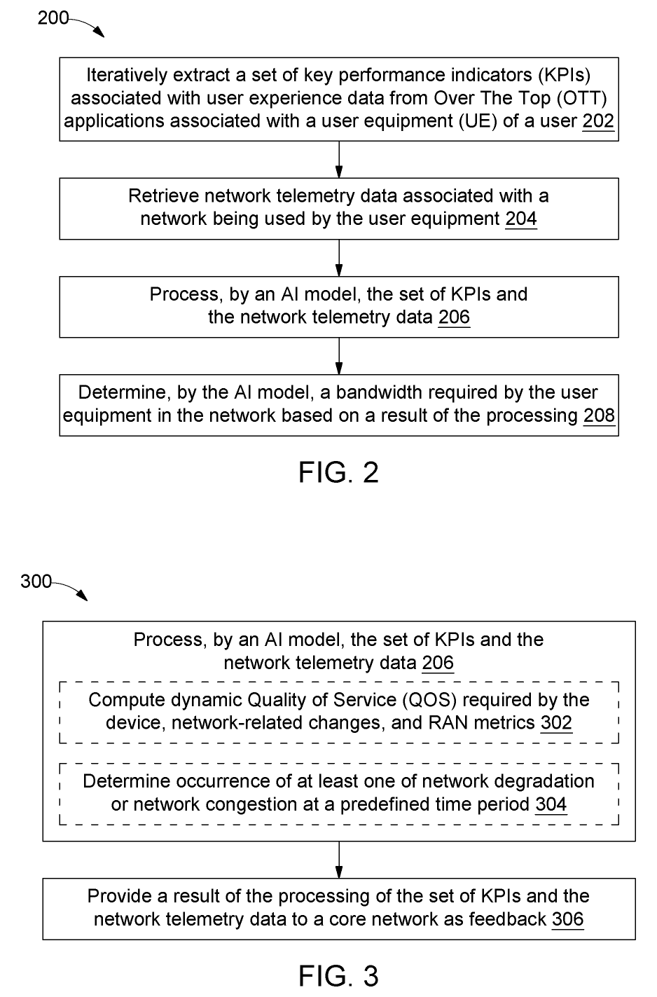

Referring now to FIG. 2, an exemplary process 200 for allocating dynamic bandwidth to UEs is depicted via a flowchart, in accordance with some embodiments. FIG. 2 is explained in conjunction with FIG. 1. The process 200 may be implemented by the system 104 of the network 100. The process 200 may include iteratively extracting, by a UEP (for example, the UEP 120), a set of KPIs associated with user experience data from OTT applications associated with a UE of a user (for example, the UE 102), at step 202. The set of KPIs may include at least one of user-perceived QOS, latency, location-based performance, battery consumption metrics, signal strength variations, movement-related performance, or packet loss.

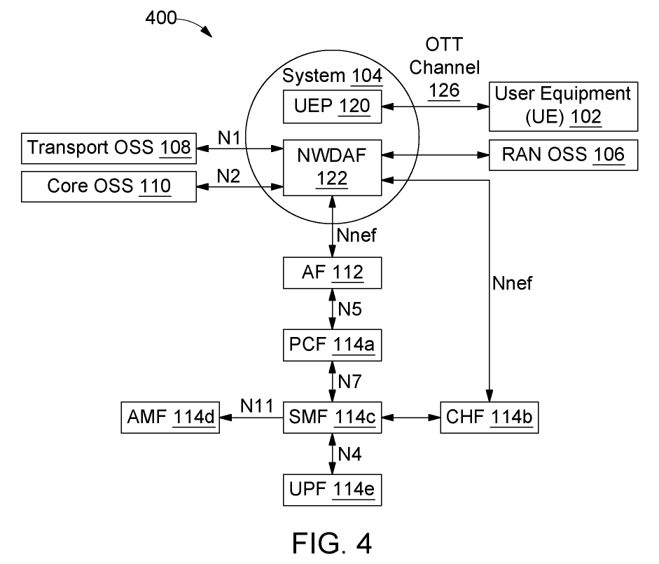

Further, the process 200 may include retrieving, by a NWDAF (for example, the NWDAF 122), network telemetry data associated with a network being used by the UE, at step 204. The network telemetry data may be retrieved through at least one of the RAN OSS (for example, the RAN OSS 106), a transport OSS (for example, the transport OSS 108), or a core OSS (for example, the core OSS 110). It should be noted that the NWDAF may include an AI model (for example, the AI model 124). Further, the process 200 may include processing, by the AI model, the set of KPIs and the network telemetry data, at step 206. Processing the set of KPIs and the network telemetry data may be explained in greater detail in conjunction with FIG. 4. Further, the process 200 may include determining, by the AI model, a bandwidth required by the UE in the network based on a result of the processing, at step 208.

Referring now to FIG. 3, an exemplary process 300 for processing a set of KPIs and network telemetry data is depicted via a flowchart, in accordance with some embodiments. FIG. 2 is explained in conjunction with FIGS. 1 and 2 . The process 300 may be implemented by the system 104 of the network 100. The process 400 may include processing, by an AI model (for example, the AI model 124), the set of KPIs and the network telemetry data, at step 206. The step 206 may include the step 302 and the step 304. The process 300 may further include computing, by the AI model, dynamic QOS required by the user device, network-related changes, and RAN metrics, at step 302. The process 300 may also include determining, by the AI model, occurrence of at least one of network degradation or network congestion at a predefined time period, at step 304. The process 300 may include providing, by the AI model, a result of the processing of the set of KPIs and the network telemetry data to a core network (for example, the 5G core network 114) as feedback, at step 306.

Referring now to FIG. 4, a flow diagram of a detailed exemplary process 400 for allocating dynamic bandwidth to UEs is illustrated, in accordance with an embodiment. FIG. 2 is explained in conjunction with FIGS. 1, 2, and 3. The process 400 may be implemented by the system 104 of the network 100. A set of KPIs (for example, location-based performance metrics, application specific KPIs, latency and response time, packet loss and jitter, user perceived quality, better consumption metrics, signal strength variation, movement-related performance, etc.) associated with UE data from OTT applications (Netflix, Amazon Prime Video, Spotify, etc.) associated with a UE of a user (for example, the UE 102) may be sent from the UE via OTT applications to the UEP 120 over a secure OTT channel 126. It should be noted that the OTT channel 126 may not be a 3GPP- defined interface. The OTT channel 126 may integrate with a network to provide essential user data. The UEP 120 may separately store the set of KPIs per user level. Further, the RAN OSS 106 may send a real-time E2 interface data (for example, the UE- Level Metrics and the cell-level metrics) to the RIC.

The RIC may process and aggregate the real-time E2 interface data. The RIC may send the processed real-time E2 interface data to the NWDAF 122 through an internal or standardized data collection interface (for example, Open-RAN (O-RAN) defined protocols or proprietary Application Programming Interface (APIs), etc.) ensuring that a comprehensive set of KPIs may be analyzed. The transport OSS 108 and the core OSS 110 may collect additional network performance metrics. The transport OSS 108 and the core OSS 110 may send the additional network performance metrics to the NWDAF 122 via N1 and N2 interface. It should be noted that the UEP 120 may send the separately stored set of KPIs to the NWDAF 122 through standard OSS communication protocols. It should be further noted that the NWDAF 122 may be a 3^{rd} Generation Partnership Project (3GPP) defined node. The NWDAF 122 may include the AI model 124. The AI model 124 may process the set of KPIs, the real-time E2 interface data, and the additional network metrics. The AI model 124 may generate the set of KPIs for prerecorded location specific real-time scenarios to avoid continuous data collection from network to avoid network overhead. Additionally, the AI model 124 may determine a bandwidth required by the user device in the network.

The NWDAF 122 may forward the bandwidth determined via a Nnef interface to the AF 112. The Nnef interface is a Network Exposure Function (NEF) based service interface. The AF 112 may act as an orchestrator to communicate with the PCF 114a. Based on the determined bandwidth, the AF 112 may send policy control instructions to the PCF 114a via N5 interface as per 3GPP TS 29.512. The PCF 114a may update QoS policies as defined by 3GPP TS 29.214 to the SMF 114c via N7 interface. Further, the PCF 114a may send QoS adjustments to the AMF 114d via N11 interface. The AMF 114d may send the QoS adjustments to the RIC via standard NG-RAN signaling. The RIC may communicate with the xApps in the RAN OSS 106 to execute AI/ML- based decisions for real-time cell adjustments (for example, PRB allocations). Further, the RIC may send a status report back to the NWDAF 122 to confirm execution and support continuous learning.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

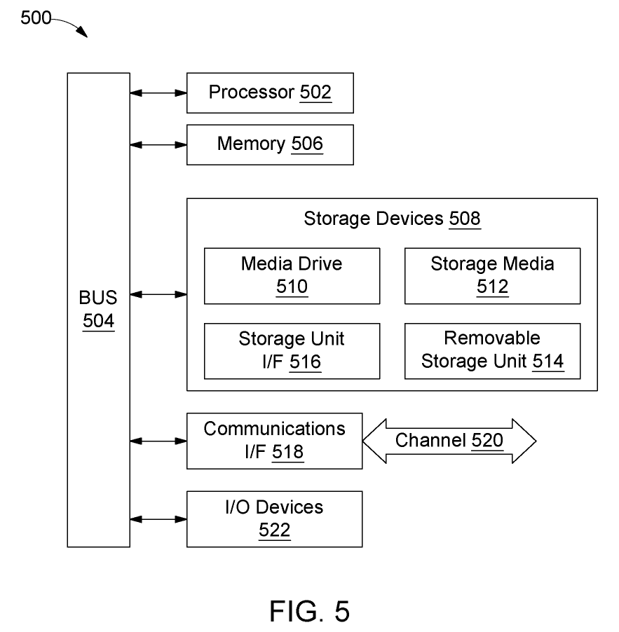

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication medium. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage devices 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 512 may include, for example, a hard disk, magnetic tape, flash drive, or other fixed or removable medium that is read by and written to by the media drive 510. As these examples illustrate, the storage media 512 may include a computer-readable storage medium having stored therein particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro-USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

Thus, the disclosed method and system try to overcome the technical problem of allocating dynamic bandwidth to UEs. The disclosed method and system may iteratively extract a set of Key Performance Indicators (KPIs) associated with user experience data from Over The Top (OTT) applications associated with a UE of a user. Further, the disclosed method and system may retrieve network telemetry data associated with a network being used by the UE. Further, the disclosed method and system may process, via an AI model, the set of KPIs and the network telemetry data. Further, the disclosed method and system may determine, by the AI model, a bandwidth required by the user device in the network based on a result of the processing.

As will be appreciated by those skilled in the art, the techniques described in the various embodiments discussed above are not routine, or conventional, or well understood in the art. The techniques may include user benefits and telecom operator benefits. The user benefits may include dynamic speed adjustments and real-time adjustments of data rates. A user may temporarily increase data rates when needed (for example, for streaming, gaming, video calls, etc.) improving overall experience. The real-time adjustments of data rates may be adjusted based on real-time feedback from user experience and performance of network to ensure optimal service. The telecom operator benefits may include increased monetization opportunities. The telecom operator may offer dynamic data rate adjustments as a paid feature creating a new revenue stream. The telecom operator benefits may further include efficient resource utilization. Network slicing and resource allocation are optimized in real-time, ensuring no wastage of bandwidth and efficient usage of resources. The telecom operator benefits may further include cost savings in term of minimizing the network telemetry KPIs as both network and computation cost could drastically come down.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for profiling programs written in interpreted programming languages. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. An Artificial Intelligence (AI) based method for allocating dynamic bandwidth to User Equipments (UEs), the method comprises:
iteratively extracting, by an end-device, a set of key performance indicators (KPIs) associated with user experience data from Over The Top (OTT) applications associated with a UE of a user;
retrieving, by the end-device, network telemetry data associated with a network being used by the UE;
processing, by an AI model in the end-device, the set of KPIs and the network telemetry data; and
determining, by the AI model in the end-device, a bandwidth required by the UE in the network based on a result of the processing.

2. The method of claim 1, wherein the set of KPIs comprises at least one of user-perceived QOS, latency, location-based performance, battery consumption metrics, signal strength variations, movement-related performance, or packet loss.

3. The method of claim 1, wherein network telemetry data is retrieved through at least one of a Radio Access Network (RAN) Operation Support System (OSS), a transport OSS, or a core OSS.

4. The method of claim 1, wherein a Network Data Analysis Function (NWDAF) comprises the AI model.

5. The method of claim 1, wherein processing the set of KPIs and the network telemetry data comprises computing dynamic Quality of Service (QOS) required by the UE, network-related changes, and RAN metrics.

6. The method of claim 1, wherein processing the set of KPIs and the network telemetry data comprises determining occurrence of at least one of network degradation or network congestion at a predefined time period.

7. The method of claim 1, further comprise providing the result of the processing of the set of KPIs and the network telemetry data to a core network as feedback.

8. An Artificial Intelligence (AI) based system for allocating dynamic bandwidth to User Equipments (UEs), the system comprises:
a processor; and
a memory communicably coupled with the processor, wherein the memory comprises processor instructions, which when executed by the processor, cause the processor to:
iteratively extract a set of key performance indicators (KPIs) associated with user experience data from OTT applications associated with a UE of a user;
retrieve network telemetry data associated with a network being used by the UE;
process, by an AI model, the set of KPIs and the network telemetry data; and
determine, by the AI model, a bandwidth required by the UE in the network based on a result of the processing.

9. The AI based system of claim 8, wherein the set of KPIs comprises at least one of user-perceived QOS, latency, location-based performance, battery consumption metrics, signal strength variations, movement-related performance, or packet loss.

10. The AI based system of claim 8, wherein network telemetry data is retrieved through at least one of a Radio Access Network (RAN) Operation Support System (OSS), a transport OSS, or a core OSS.

11. The AI based system of claim 8, wherein a Network Data Analysis Function (NWDAF) comprises the AI model.

12. The AI based system of claim 8, wherein to process the set of KPIs and the network telemetry data, the processor instruction further cause the processor to compute dynamic Quality of Service (QOS) required by the UE, network-related changes, and RAN metrics.

13. The AI based system of claim 8, wherein to process the set of KPIs and the network telemetry data, the processor instruction further cause the processor to determine occurrence of at least one of network degradation or network congestion at a predefined time period.

14. The AI based system of claim 8, wherein the processor instructions further cause the processor to provide the result of the processing of the set of KPIs and the network telemetry data to a core network as feedback.

15. A non-transitory computer-readable medium storing computer-executable instructions for allocating dynamic bandwidth to User Equipments (UEs) using Artificial Intelligence (AI), the computer-executable instructions configured for:
iteratively extracting a set of key performance indicators (KPIs) associated with user experience data from OTT applications associated with a UE of a user;
retrieving network telemetry data associated with a network being used by the UE;
processing, via an AI model, the set of KPIs and the network telemetry data; and
determining, via the AI model, a bandwidth required by the UE in the network based on a result of the processing.

16. The non-transitory computer-readable medium of claim 15, wherein the set of KPIs comprises at least one of user-perceived QOS, latency, location-based performance, battery consumption metrics, signal strength variations, movement-related performance, or packet loss.

17. The non-transitory computer-readable medium of claim 15, wherein network telemetry data is retrieved through at least one of a Radio Access Network (RAN) Operation Support System (OSS), a transport OSS, or a core OSS.

18. The non-transitory computer-readable medium of claim 15, wherein the computer-executable instructions are configured for computing at least one of dynamic Quality of Service (QOS) required by the UE, network-related changes, or RAN metrics.

19. The non-transitory computer-readable medium of claim 15, wherein the computer-executable instructions are configured for determining occurrence of at least one of network degradation or network congestion at a predefined time period.

20. The non-transitory computer-readable medium of claim 15, wherein the computer-executable instructions are configured for providing the result of the processing of the set of KPIs and the network telemetry data to a core network as feedback.
